(19) United States
(12) Patent Application Publication
(10) Pub. No.: US 2007/0206561 A1
(43) Pub. Date: Sep. 6, 2007

(54) Method and system for transmitting/receiving data in a communication system

(75) Inventors: Yeong-Moon Son, Anyang-si (KR); Pan-Yuh Joo, Seoul (KR); Jung-Je Son, Seongnam-si (KR); Jae-Weon Cho, Suwon-si (KR); Sung-Jin Lee, Suwon-si (KR); Hyun-Jeong Kang, Seoul (KR); Song-Nam Hong, Seoul (KR); Mi-Hyun Lee, Seoul (KR); Hyoung-Kyu Lim, Seoul (KR); Young-Ho Kim, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/704,169

(22) Filed: Feb. 8, 2007

(30) Foreign Application Priority Data
Feb. 8, 2006 (KR) 12151/2006

(51) Int. Cl. H04J 3/16

(52) U.S. Cl. 370/346; 370/445

(57) ABSTRACT

A method for transmitting and receiving data in a communication system. The method includes grouping, by a Base Station (BS), Mobile Stations (MSs) using a real-time service, into groups, allocating burst blocks to the groups, and allocating data bursts of burst blocks to the MSs; and determining, by each MS, whether its own uplink burst is allocated, and transmitting data to the BS through a sub-burst of a burst block allocated to a group to which each MS belongs.

### PRIORITY

This application claims the benefit under 35 U.S.C. § 119(a) of a Korean Patent Application filed in the Korean Intellectual Property Office on Feb. 8, 2006 and assigned Serial No. 2006-12151, the disclosure of which is incorporated herein by reference.

### BACKGROUND OF THE INVENTION

1. Field of the Invention

The present invention generally relates to a communication system, and more particularly to a method and system for transmitting/receiving data in a communication system.

2. Description of the Related Art

Communication systems provide services using limited resources. In order to provide various services using limited resources, wireless systems use a scheduling scheme for efficiently employing resources. A conventional communication method between a Base Station (BS) and a Mobile Station (MS) used in the scheduling scheme will now be described.

The BS provides the MS using uplink resource allocation with control information including parameters such as a Connection IDentifier (CID) of the MS, bandwidth information allocated for a connection, and the like in every frame. Upon receiving the control information, the MS transmits data using an uplink region allocated from the BS. The CID includes, for example, a Medium Access Control (MAC) address or CID of the MS, and the like.

To report uplink resource allocation to the MS, the BS should include and transmit control information, for example, an uplink MAP (UL-MAP) Information Element (IE), to be received and decoded by the MS in a control information message, for example, a UL-MAP message, of every frame.

The uplink control information message, that is, the UL-MAP message, is broadcast to MSs through a UL-MAP region of the frame. The format of the UL-MAP message can be expressed as shown in Table 1.

TABLE 1

| Syntax | Size | Notes |
|---|---|---|
| UL-MAP Message_Format( ) { | | |
| Management Message Type = | 8 bits | |
| 3 | | |
| Uplink channel ID | 8 bits | |
| UCD Count | 8 bits | |
| Allocation Start Time | 32 bits | |
| Begin PHY Specific Section { | | See applicable PHY section |
| for (i = 1; i < = n, i++) { | | For each UL-MAP element |
| | | 1 to n |
| UL-MAP_IE( ) | variable | See corresponding PHY |
| | | specification |
| } | | |
| } | | |
| if ! (byte boundary){ | | |
| Padding Nibble | 4 bits | Padding to reach byte |
| | | boundary |
| } | | |
| } | | |

As shown in Table 1, the UL-MAP message contains multiple IEs, that is, a management message type IE for indicating a type of message to be transmitted, an uplink channel ID IE for indicating a channel ID to be used, an Uplink Channel Descriptor (UCD) count IE for indicating a count mapped to a configuration change of a UCD message including a DL burst profile and multiple UL-MAP IEs for indicating a size, position and attribute of each data burst constructing an uplink frame. The uplink channel ID is uniquely allocated to a MAC sublayer.

As shown in Table 1, the UL-MAP IEs are control information to be used to allocate uplink resources to MSs. In other words, a UL-MAP IE indicates whether a burst, that is, an uplink resource, has been allocated for an MS in a current uplink frame. One UL-MAP IE includes information for one MS.

To determine whether an uplink resource has been allocated for the MS, the MS should receive and decode a UL-MAP IE within the UL-MAP message transmitted from the BS. The format of the UL-MAP IE can be expressed as shown in Table 2.

TABLE 2

| Syntax | Size | Notes |
|---|---|---|
| UL-MAP IE( ) { | | |
| CID | 16 bits | |
| UIUC | 4 bits | |
| if (UIUC ==12){ | | |
| OFDMA Symbol offset | 8 bits | |
| Subchannel offset | 7 bits | |
| No. OFDMA Symbols | 7 bits | |
| No. Subchannels | 7 bits | |
| Ranging Method | 2 bits | 0b00 - Initial Ranging over |
| | | two symbols |
| | | 0b01 - Initial Ranging over |
| | | four symbols |
| | | 0b10 - BW Request/Periodic |
| | | Ranging over one symbol |
| | | 0b11 - BW Request/Periodic |
| | | Ranging over three symbols |
| reserved | 1 bit | Shall be set to zero |
| } else if (UIUC==14){ | | |
| CDMA_Allocation_IE( ) | 32 bits | |
| else if (UIUC==15){ | | |
| Extended UIUC | variable | See clauses following |
| dependent IE | | 8.4.5.4.3 |
| } else { | | |
| Duration | 10 bits | In OFDMA slots (see 8.4.3.1) |
| Repetition coding | 2 bits | 0b00 - No repetition coding |
| indication | | 0b01 - Repetition coding of 2 |
| | | used |
| | | 0b10 - Repetition coding of 4 |
| | | used |
| | | 0b11 - Repetition coding of 6 |
| | | used |
| } | | |
| Padding nibble, if needed | 4 bits | Completing to nearest byte, |
| | | shall be set to 0 |
| } | | |

As shown in Table 2, the UL-MAP IE includes a CID for indicating an MS using an uplink data burst, an Uplink Interval Usage Code (UIUC) for identifying a type of the UL-MAP IE and different IEs corresponding to UIUC values. For example, for UIUC=12, an MS uses the UL-MAP IE to indicate resource allocation information used for ranging to a BS, that is, to indicate a position, size and attribute of an uplink frame. In other words, a UL-MAP IE with UIUC=12 indicates a start point of a ranging region using an Orthogonal Frequency Division Multiple Access (OFDMA) symbol offset for indicating a distance from the start of an associated frame in an OFDMA symbol unit and a subchannel offset for indicating a distance from Subchannel 0 in a subchannel index unit. As shown in Table 2, the UL-MAP IE indicates ranging resource allocation information from the start point using ‘No. OFDMA Symbols’ for indicating the number of symbols in a data burst and ‘No. Subchannels’ for indicating the number of subchannel indexes. In addition, the UL-MAP IE indicates whether an allocated ranging region is used for initial ranging or bandwidth request/periodic ranging using ‘Ranging Method’.

As described above, the UL-MAP message can include two ranging regions, that is, a ranging region for initial ranging (Ranging Method=0b00 or 0b01) and a ranging region for bandwidth request/periodic ranging (Ranging Method=0b10 or 0b11). In addition, the UL-MAP message may not include the UL-MAP IE with UIUC=12. The MS may not make a ranging attempt in an uplink frame excluding the UL-MAP IE with UIUC=12 and may perform ranging in an uplink frame including the UL-MAP IE with UIUC=12.

UL-MAP IEs with UIUC=1 to UIUC=11 include a size of data bursts used for a fast feedback channel, a true data transmission of the MS and an indication of the end of a UL-MAP region, that is, the duration of an OFDMA slot unit, and a used repetition coding indication field, respectively. The data bursts for the true data transmission of the MS are allocated in an uplink frame space using a one-dimensional allocation method. In the uplink frame space, a two-dimensional (2D) allocation process allocates bursts in a rectangular form according to UL-MAP IEs with UIUC=12, UIUC=14 and UIUC=15. In an unallocated region, bursts are sequentially allocated in an OFDMA slot unit in order of frequencies or OFDMA symbols of UL-MAP IEs of the MSs with UIUC=1 to UIUC=11.

The UL-MAP IEs with UIUC=1 to UIUC=11 are one-to-one mapped to UCD messages indicating modulation/coding methods and physical characteristics for their bursts. That is, the UCD message includes an uplink burst profile. Thus the MS should know in advance UCD information before receiving and decoding the UL-MAP message.

When ranging has failed, the MS sets a random backoff value to increase a success probability in the next ranging attempt, and makes a ranging attempt again after a lapse of a backoff time. Information used to set the backoff value is also included in the UCD message. The format of the UCD message can be expressed as shown in Table 3.

TABLE 3

| Syntax | Size | Notes |
|---|---|---|
| UCD-Message_Format( ){ | | |
| Management Message Type = 0 | 8 bits | |
| Uplink channel ID | 8 bits | |
| Configuration Change Count | 8 bits | |
| Mini-slot size | 8 bits | |
| Ranging Backoff Start | 8 bits | |
| Ranging Backoff End | 8 bits | |
| Request Backoff Start | 8 bits | |
| Request Backoff End | 8 bits | |
| TLV Encoded Information for the overall | Variable | |
| channel | | |
| Begin PHY Specific Section { | | |
| for (i=1; i <n; i+n) | | |
| Uplink_Burst_Descriptor | Variable | |
| } | | |
| } | | |
| } | | |

As show in Table 3, the UCD message includes a plurality of IEs, that is, a management message type IE for indicating a type of message to be transmitted, an uplink channel ID IE for indicating an uplink channel ID to be used, a configuration change count IE for indicating a configuration change count counted in a BS, a mini-slot size IE for indicating a mini-slot size of an uplink physical channel, a ranging backoff start IE for indicating a start point of a backoff for initial ranging, that is, a size of an initial backoff window for initial ranging, a ranging backoff end IE for indicating an end point of a backoff for the initial ranging, that is, a size of a final backoff window, a request backoff start IE for indicating a start point of a backoff for contention data and requests, that is, a size of a first backoff window and a request backoff end IE for indicating an end point of a backoff for contention data and requests, that is, a size of the final backoff window.

Upon power-on, the MSs monitor all preset frequency bands to detect a pilot channel signal at a highest level, that is, a highest pilot Carrier-to-Interference and Noise Ratio (CINR). An MS regards a BS from which a pilot channel signal is transmitted at the highest pilot CINR as that to which the MS currently belongs to. The MS retrieves DL-MAP and UL-MAP messages of a downlink frame transmitted from the BS to detect uplink/downlink control information and information for indicating actual data transmission/reception points.

As seen from the description of the UL-MAP message, a UL-MAP IE indicating an associated MS is included in the UL-MAP, message transmitted in every frame when the BS allocates uplink resources to the MSs.

On the other hand, the BS uses pre-connection setup for allocating uplink resources to the MSs. For this, a connection procedure will be described with reference to FIG. 1.

FIG. 1 shows a connection setup procedure between an MS and a BS in a conventional communication system. In particular, FIG. 1 shows a Dynamic Service Addition (DSA) procedure for generating a new service flow in the MS 110. That is, every connection between the MS and the BS is set up through the DSA procedure as shown in FIG. 1.

Referring to FIG. 1, the MS 110 provides the BS 130 with a Dynamic Service Addition REQuest (DSA-REQ) message including service parameters for an associated service flow to add the new service flow in step 121. The format of the DSA-REQ message can be expressed as shown in Table 4.

TABLE 4

| Syntax | Size | Notes |
|---|---|---|
| DSA- | | |
| REQ_Message_Format( ){ | | |
| Management Message Type | 8 bits | TBD |
| = 11 | | |
| Transaction ID | 16 bits | Unique identifier for this |
| | | transaction assigned by |
| | | the sender |
| TLV Encoded Information | Variable | TLV specific |
| } | | |

As shown in Table 4, the DSA-REQ message includes a management message type field, a transaction ID field and a type/length/value (TLV) encoded information field. The transaction ID field indicates a transaction ID. When the MS performs multiple dynamic service-related processes, that is, DSx_xxx messages are transmitted, arbitrary values are designated to identify these messages. The TLV encoded information field may be optionally included, if needed.

The MS 110 includes information indicating a service scheduling request in the TLV encoded information field of the DSA-REQ message and provides the MS 130 with the information. The indication information can be expressed as shown in Table 5.

TABLE 5

| Type | Length | Value | Scope |
|---|---|---|---|
| [145/146].11 | 1 | 0: Reserved | DSA-REQ |
| | | 1: for Undefined (BS | DSA-RSP |
| | | implementation-dependent) | DSA-ACK |
| | | 2: for BE (default) | |
| | | 3: for nrtPS | |
| | | 4: for rtPS | |
| | | 5: for Extended rtPS | |
| | | 6: for UGS | |
| | | 7-255: Reserved | |

As shown in Table 5, the MS includes its own service flow scheduling information request in the TLV encoded information field and transmits the DSA-REQ message to the BS 130. When receiving the DSA-REQ message, the BS 130 detects a service flow scheduling method requested by the MS 110 through the TLV encoded information field of the DSA-REQ message.

The BS 130 can transmit the DSA-REQ message for connection setup to the MS 110. In a connection setup request procedure, a connection may be set up by transmitting the DSA-REQ message from the MS 110 to the BS 130. Alternatively, the connection may be set up by transmitting the DSA-REQ message from the BS 130 to the MS 110.

When the BS 130 transmits the DSA-REQ message to the MS 110, information to be included in a Dynamic Service Addition Response (DSA-RSP) message is included and transmitted in the DSA-REQ message as shown in Table 7. In the connection setup request procedure, the MS 110 or the BS 130 may request the connection setup. For convenience of explanation, an example in which the MS 110 requests service connection setup has been described.

When receiving the DSA-REQ message from the MS 110, the BS 130 transmits a Dynamic Service X Received (DSX-RVD) message to the MS 110 in step 123. The DSX-RVD message is used to notify the MS 110 that the BS 130 normally receives and processes a DSA related message such as the DSA-REQ message. The format of the DSX-RVD message can be expressed as shown in Table 6.

TABLE 6

| Syntax | Size | Notes |
|---|---|---|
| DSX- | | |
| RVD_Message_Format( ){ | | |
| Management Message Type | 8 bits | TBD |
| = 30 | | |
| Transaction ID | 16 bits | |
| Confirmation Code | 8 bits | |
| } | | |

As shown in Table 6, the DSX-RVD message uses the same transaction ID value as the DSA-REQ message. Thus the MS 110 can detect that the DSX-RVD message is a response to the DSA-REQ message.

Then the BS 130 provides the MS 110 with a DSA-RSP message serving as a response to a broadcast service connection request in step 125. The format of the DSA-RSP message can be expressed as shown in Table 7.

TABLE 7

| Syntax | Size | Notes |
|---|---|---|
| DSA- | | |
| RSP_Message_Format( ){ | | |
| Management Message Type | 8 bits | TBD |
| = 12 | | |
| Transaction ID | 16 bits | |
| Confirmation Code | 8 bits | |
| TLV Encoded Information | Variable | TLV specific |
| } | | |

As shown in Table 7, the DSA-RSP message contains a management message type field, a transaction ID field, a confirmation code field and a TLV encoded information field. A Confirmation Code (CC) has a structure as shown in Table 8 and includes response information to the DSA-REQ message.

TABLE 8

| CC | Status |
|---|---|
| 0 | OK/success |
| 1 | reject-other |
| 2 | reject-unrecognized-configuration-setting |
| 3 | reject-temporary/reject-resource |
| 4 | reject-permanent/reject-admin |
| 5 | reject-not-owner |
| 6 | reject-service-flow-not-found |
| 7 | reject-service-flow-exists |
| 8 | reject-required-parameter-not-present |
| 9 | reject-header-suppression |
| 10 | reject-unknown-transaction-id |
| 11 | reject-authentication-failure |
| 12 | reject-add-aborted |
| 13 | reject-exceeded-dynamic-service-limit |
| 14 | reject-not-authorized-for-the-requested-SAID |
| 15 | reject-fail-to-establish-the-requested-SA |

When transmitting a positive response to the DSA-REQ message as shown in Table 8, the BS 130 uses 0 (OK/success) as a CC value of the DSA-RSP message. In this case, a Quality of Service (QoS) parameter and a service ID, for example, a multicast CID or transport CID, for an associated broadcast service are contained in the DSA-RSP message in TLV encoding form as shown in Table 9. Since the remaining code values excluding the code value 0 are not directly related to the present invention, a description is omitted.

TABLE 9

| Type | Length | Value | Scope |
|---|---|---|---|
| [145/146].2 | 2 | CID | DSx-REQ |
| | | | DSx-RSP |
| | | | DSx-ACK |

When the MS 110 transmits a DSA-REQ message mapped to a general connection request, the CID of Table 9 should be set to a CID for a service mapped to the general connection request.

When receiving the DSA-RSP message, the MS 110 transmits a Dynamic Service Addition Acknowledge (DSA-ACK) message to the BS 130 in step 127. The format of the DSA-ACK message can be expressed as shown in Table 10.

TABLE 10

| Syntax | Size | Notes |
|---|---|---|
| DSA- | | |
| ACK_Message_Format( ){ | | |
| Management Message Type | 8 bits | TBD |
| = 13 | | |
| Transaction ID | 16 bits | |
| Confirmation Code | 8 bits | |
| TLV Encoded Information | Variable | TLV specific |
| } | | |

As shown in Table 10, the DSA-ACK message contains a management message type field, a transaction ID field, a confirmation code field and a TLV encoded information field.

As described above, it can be seen that a service connection requested by an MS is set up through a procedure in which the MS transmits one DSA-REQ message to a BS and the BS transmits a DSA-RSP message to the MS in a communication system.

On the other hand, various uplink scheduling methods are being proposed for a real-time service based on a conventional Internet Protocol (IP) network, for example, a voice over Internet Protocol (VoIP) service. Representative examples are an Unsolicited Grant Service (UGS), real-time Polling Service (rtPS) and extended real-time Polling Service (ertPS).

The UGS periodically allocates a fixed size uplink bandwidth whose delay is guaranteed from the BS to the MS. When a connection between the MS and the BS is established for the UGS, the BS allocates the uplink bandwidth to the MS until the connection is released without a special signaling process.

The rtPS periodically allocates a variable size uplink bandwidth whose delay is guaranteed from the BS to the MS. In the rtPS, resources are allocated in response to a periodic uplink resource allocation request. Thus the MS transmits data by receiving resource allocation suitable for an amount of data to be transmitted therefrom. An uplink bandwidth allocation procedure in the rtPS is as follows.

That is, the BS transmits a unicast polling signal to a selected MS for receiving the rtPS through downlink. When receiving the unicast polling signal from the BS, the MS transmits a bandwidth request to the BS through uplink. When receiving the bandwidth request from the MS, the BS allocates the uplink bandwidth requested by the MS through the downlink if the bandwidth requested by the MS is available.

The ertPS periodically allocates a variable size uplink bandwidth whose delay is guaranteed from the BS to the MS. An uplink bandwidth allocation procedure for the ertPS is performed like that for the rtPS.

FIG. 2 shows an uplink resource scheduling procedure for the UGS in a conventional communication system. The status of an MS is divided into two types on the time axis. That is, a talk-spurt period 240 is mapped to an ON status in which a data packet to be transmitted from the MS is present and silence periods 230 and 250 are mapped to an OFF status in which a data packet to be transmitted is absent. The same resources are allocated to the MS in the talk-spurt period 240 and the silence periods 230 and 250. In particular, FIG. 2 shows an example in which resources capable of supporting Rate 1 corresponding to a maximum data rate are constantly allocated.

However, the MS does not use all the allocated resources to transmit data. In the silence periods 230 and 250 in which a data packet to be transmitted from the MS is absent, the MS uses only minimum resources necessary to maintain the service (for example, Rate ⅛).

There may occur the case where the allocated resources are partially used in the talk-spurt period 240. That is, the MS transmits data packets using the whole or part of the resources in the talk-spurt period 240. For example, the MS transmits data packets at a maximum data rate (for example, Rate 1) in a period 212. In this case, all the allocated resources may be used. Due to a decreased number of data packets, data packets are transmitted at Rate ½ in a period 214. In this case, only ½ of the allocated resources may be used. As the amount of transmission data is further reduced, the MS transmits the data packets at Rate ¼ in a period 216. In this case, only ¼ of the allocated resources may be used.

In a period in which a data packet to be transmitted is absent, for example, the silence period 250, the MS uses only minimum resources. The minimum resources support a minimum data rate in the MS, for example, Rate ⅛.

As described above, part of the constantly allocated resources remains as surplus resources in the periods 214, 216 and 218 in which a maximum data rate is unused. The presence of the surplus resources implies inefficient uplink scheduling. Thus, there is a problem in that uplink resources may be wasted in the talk-spurt periods as well as in the silence periods.

The BS should include an associated UL-MAP IE in a UL-MAP message such that uplink data can be periodically transmitted on an MS-by-MS basis even when MSs periodically use fixed uplink resources for the UGS. Also in a state in which a data transmission period and a size of data to be allocated to the MS are fixed, the BS should periodically transmit a UL-MAP IE to the MS.

The UGS is mainly used for a voice service in which an amount of data to be simultaneously transmitted from the MS is not large. There is a problem in that a 32-bit UL-MAP IE should be provided to transmit a small amount of data in terms of an amount of UGS data to be transmitted from the MS and overhead for signaling uplink resource allocation. Uplink resources are to be efficiently used by minimizing overhead according to transmission data amount and transmission period negotiated between the MS and the BS.

FIG. 3 shows an uplink resource scheduling procedure for the rtPS in the conventional communication system. The status of an MS is divided into two types on the time axis. That is, a talk-spurt period 370 is mapped to an ON status in which a data packet to be transmitted from the MS is present and silence periods 360 and 380 are mapped to an OFF status in which a data packet to be transmitted is absent.

In the rtPS, the MS sends an uplink resource allocation request to a BS in steps 312 to 336. Requested resources are set based on the amount of packet data to be transmitted from the MS. The BS allocates the requested uplink resources to the MS. Then the MS transmits the data packets using the allocated resources in periods 310, 320 and 330.

The talk-spurt period 370 in which the MS transmits data packets is divided into the three periods 310, 320 and 330 according to data rates. Among the three periods 310, 320 and 330, the first period 310 is that in which a data packet is transmitted at Rate 1, the second period 320 is that in which a data packet is transmitted at Rate ½ and the third period 330 is that in which a data packet is transmitted at Rate ¼. It can be seen that the MS requests different resources on a period-by-period basis. A change from the period 310 to the period 320 and a change from the period 320 to the period 330 are made due to reduced data rates in the MS.

More specifically, when a data packet to be transmitted in the silence period 360 is generated, the MS sends a resource allocation request to the BS (as indicated by reference numeral 312). In response to the resource allocation request, the BS allocates maximum resources for supporting a maximum data rate, for example, Rate 1. The MS transmits the data packets at Rate 1 using the resources allocated by the BS (as indicated by reference numeral 310). The data packet transmission at Rate 1 is repeated in the period 310.

When a data rate is to be changed due to a decreased number of data packets to be transmitted in the period 310, the MS requests resource allocation for supporting a decreased data rate (for example, Rate ½) (as indicated by reference numeral 322). Then the MS transmits the data packets using allocated resources (as indicated by reference numeral 320). The data packet transmission at Rate ½ is repeated in the period 320.

When the data rate further decreases in the period 320, the MS requests resource allocation for supporting the further decreased data rate (for example, Rate ¼ (as indicated by reference numeral 332). Then the MS transmits a data packet at Rate ¼ (as indicated by reference numeral 330). The data packet transmission at Rate ¼ is repeated in the period 330.

After completing the data packet transmission, the MS operates in the silence period 380 in which the minimum resources are used, for example, at Rate ⅛.

To support the rtPS as described above, a periodic polling process, that is, an uplink resource request process (as indicated by reference numerals 312 to 318, 322 to 326 or 332 to 336), is used. Also in the period 310, 320 or 330 using the data packet transmission based on the same resources, the periodic polling process (as indicated by reference numerals 314 to 318, 324 to 326 or 334 to 336) should be performed. Thus, there is a problem in that an unnecessary polling process leads to a waste of uplink resources.

Since uplink resources are periodically allocated according to scheduling types regardless of a real-time status of the MS in the real-time services, for example, the UGS and rtPS, as described above, efficient uplink scheduling reflecting a time-variant status of the MS may not be performed.

In other words, the BS should perform a periodic polling process for allocating uplink resources such that the MS can transmit a 16-bit bandwidth (BW) request header through uplink in order to determine whether there is data to be transmitted from the MS using the rtPS. For this, the BS should include a UL-MAP IE for the BW request header of the associated MS in a UL-MAP message. There is a problem in that a 32-bit UL-MAP IE should be included in the UL-MAP message to periodically allocate fixed uplink resources for the BW request header of the MS as described with reference to the UGS.

### SUMMARY OF THE INVENTION

The present invention addresses at least the above problems and/or disadvantages and provides at least the advantages described below. Accordingly, an aspect of the present invention is to provide a method and system for transmitting/receiving data in a communication system.

Another aspect of the present invention is to provide a method and system for transmitting/receiving data that can efficiently allocate resources to a mobile station for a real-time service in a communication system.

A further aspect of the present invention is to provide a method and system for transmitting/receiving data that can reduce overhead information for a mobile station using a real-time service in a communication system.

Still another aspect of the present invention is to provide a method and system for transmitting/receiving data that can reduce overhead information for periodic/fixed uplink resources allocated to a mobile station using a real-time service in a communication system.

In accordance with an aspect of the present invention, there is provided a method for transmitting and receiving data in a communication system. The method includes grouping, by a Base Station (BS), Mobile Stations (MSs) using a real-time service, into groups, allocating burst blocks to the groups, and allocating data bursts of burst blocks to the MSs; and determining, Pby each MS, whether its own uplink burst is allocated, and transmitting data to the BS through a sub-burst of a burst block allocated to a group to which each MS belongs.

In accordance with another aspect of the present invention, there is provided a method for transmitting and receiving data in a communication system. The method includes generating, by a Base Station (BS), uplink MAP message information and adding the generated uplink MAP message information to an uplink MAP message; determining whether there is a burst block to be scheduled in a frame when the uplink MAP message information is completely added; generating and setting information for allocating data bursts of the burst block to Mobile Stations (MSs) when there is the burst block to be scheduled; determining whether sub-burst allocation for the MSs is used in the burst block; allocating sub-bursts of the burst block when the sub-burst allocation of the burst block is used; determining whether sub-burst allocation for MSs with an offset or more is used when the sub-burst allocation of the burst block is not used; allocating a sub-burst of the burst block when the sub-burst allocation for at least one MS is used; and updating the information for allocating the data bursts when the sub-burst allocation for the MS is not used, adding the updated information to the uplink MAP message, and broadcasting the uplink MAP message to the MSs.

In accordance with a further aspect of the present invention, there is provided a method for transmitting and receiving data in a communication system. The method includes receiving, by a Mobile Station (MS), an uplink MAP message from a Base Station (BS) and determining whether data burst allocation information is included in the uplink MAP message; determining whether the data burst allocation information indicates a burst block for the MS when the data burst allocation information is determined to be present in the uplink MAP message; determining whether a bit for a sub-burst offset is allocated in a sub-burst bitmap indicating sub-burst allocation when the data burst allocation information is determined to indicate the burst block for the MS; checking the bit for the sub-burst offset of the MS when the bit for the sub-burst offset of the MS is determined to be present; detecting that a sub-burst of the burst block for the MS is allocated when the bit for the sub-burst offset of the MS is set to 1 and checking a position of the sub-burst within the burst block; and transmitting uplink data to the BS through the sub-burst of the burst block at a Modulation and Coding Scheme (MCS) level based on system setting.

In accordance with still another aspect of the present invention, there is provided a system for transmitting and receiving data in a communication system. The system includes a Base Station (BS) for grouping Mobile stations (MSs) using a real-time service, into groups, allocating burst blocks to the groups, and allocating data bursts of burst blocks to the MS; and an MS for determining whether its own uplink burst is allocated, and transmitting data to the BS through a sub-burst of a burst block allocated to a group to which the MS belongs.

### BRIEF DESCRIPTION OF THE DRAWINGS

The above and other features and advantages of the present invention will be more apparent from the following detailed description taken in conjunction with the accompanying drawings, in which:

FIG. 1 illustrates a connection setup procedure between a Mobile Station (MS) and a Base Station (BS) in a conventional communication system;

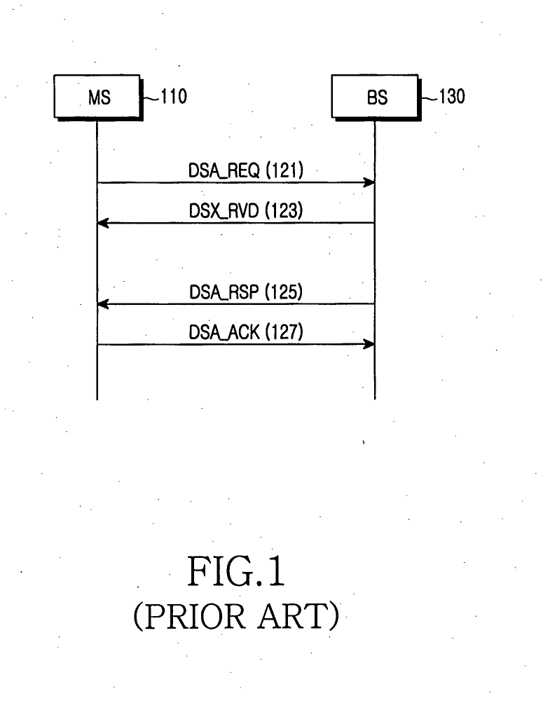

FIG. 2 illustrates a scheduling procedure for uplink resources according to Unsolicited Grant Service (UGS) in the conventional communication system;

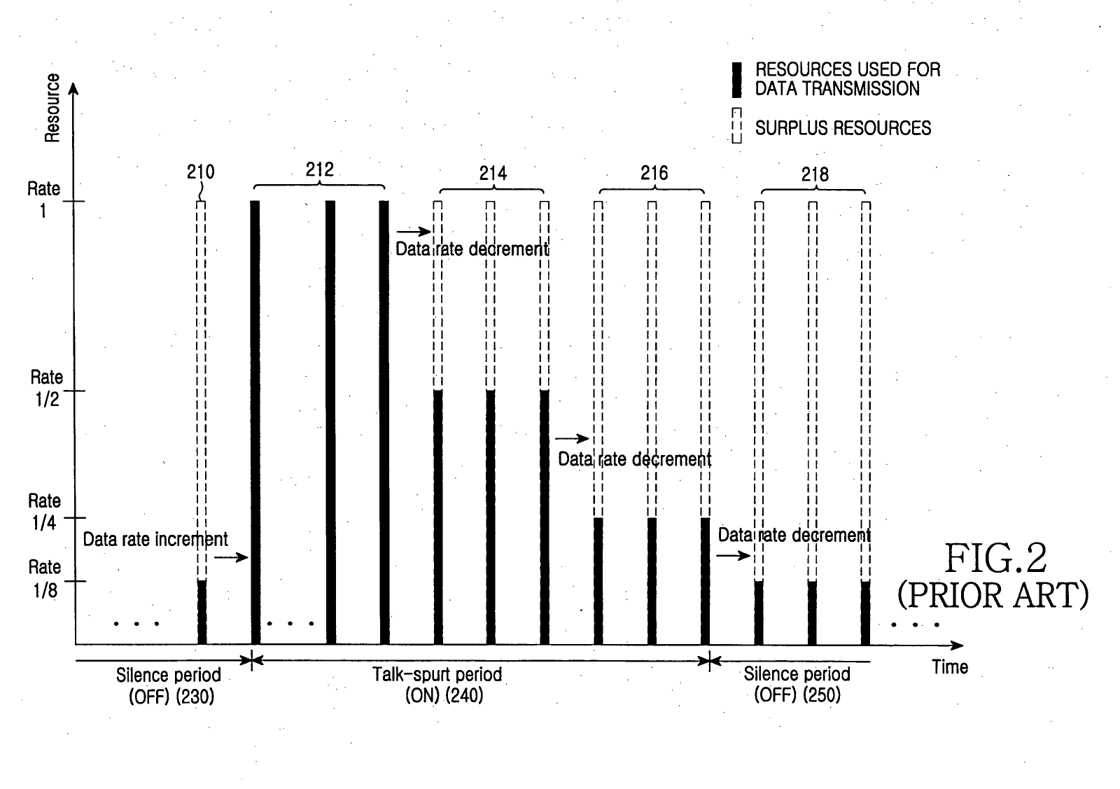

FIG. 3 illustrates a scheduling procedure for uplink resources according to real-time Polling Service (rtPS) in the conventional communication system;

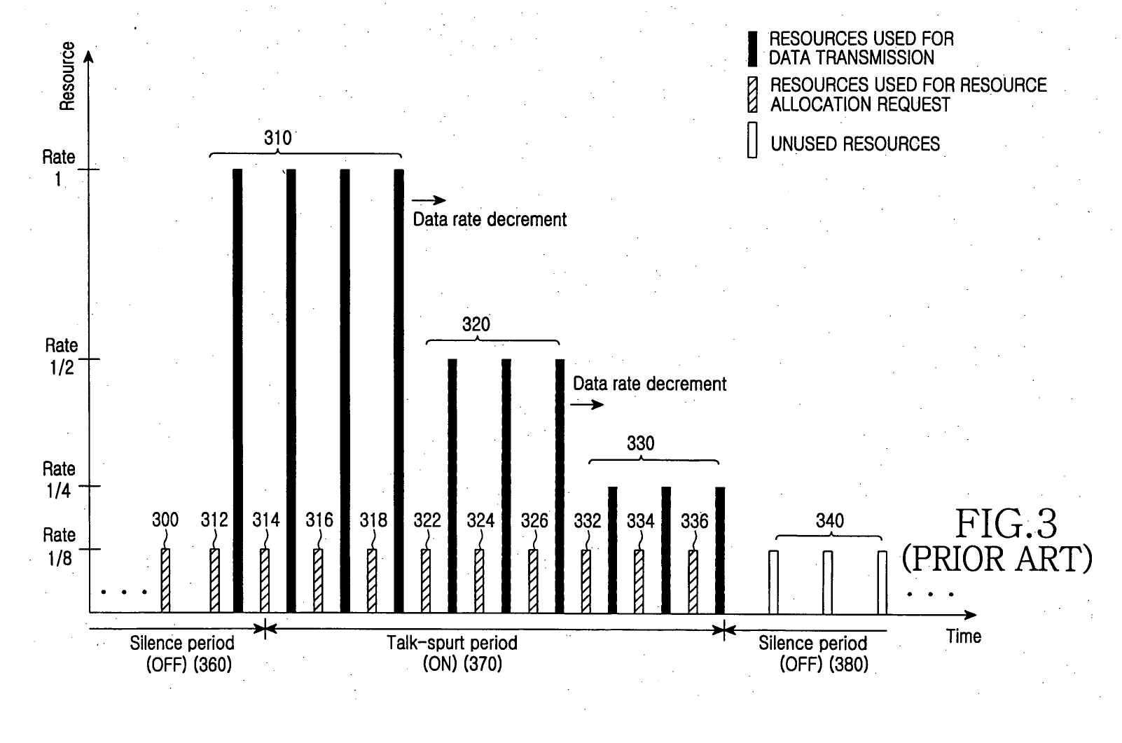

FIG. 4 illustrates a frame structure in a communication system in accordance with the present invention;

FIG. 5 is a flowchart illustrating a data burst allocation process for a real-time service in the communication system in accordance with the present invention; and

FIG. 6 is a flowchart illustrating an operation of an MS for uplink scheduling of a real-time service in the communication system in accordance with the present invention.

### DETAILED DESCRIPTION OF THE PREFERRED EMBODIMENTS

Preferred embodiments of the present invention will be described in detail herein below with reference to the accompanying drawings. Descriptions of well-known functions and constructions are omitted for clarity and conciseness.

Terms or words used in the specification and the claims are not limited to conventional or dictionary definitions, but should be interpreted as meanings and concepts that conform to the technical spirit of the present invention, based on the principle that an inventor(s) can adequately define the concepts of words in order to explain the invention in the best way. The matters defined in the description, such as a detailed construction and elements, are provided to assist in a comprehensive understanding of preferred embodiments of the invention. Those of ordinary skill in the art will recognize that various equivalents and modifications of the embodiments described herein can be made at the time of filing the application.

The present invention provides a method and system for transmitting/receiving data in a communication system, for example, an Institute of Electrical and Electronics Engineers (IEEE) 802.16 communication system serving as a broadband wireless access (BWA) communication system. In the present invention as described below, for convenience of explanation, an example of a communication system based on Orthogonal Frequency Division Multiplexing/Orthogonal Frequency Division Multiple Access (OFDM/OFDMA) in IEEE 802.16 communication systems will be described. A data transmission/reception-method and system provided in the present invention can be applied to other communication systems.

The present invention provides a method and system for transmitting/receiving data by allocating uplink resources for a real-time service in the communication system. As described below, the present invention provides an uplink resource allocation method and system for a real-time service based on an Internet Protocol (IP) network, for example, a voice service. The real-time service can include an Unsolicited Grant Service (UGS), real-time Polling Service (rtPS), extended real-time Polling Service (ertPS), and the like. The present invention provides a method and system for transmitting/receiving data by allocating uplink resources in the real-time service.

The present invention provides a data transmission/reception method and system that can reduce overhead information for a Mobile Station (MS) using allocated resources when periodic/fixed uplink resources are allocated for the real-time service, for example, the UGS or rtPS, in the communication system. In the present invention as described below, MSs using real-time services of the UGS, the rtPS and the like are grouped and one burst block is allocated to each group. Then sub-bursts within the burst block are allocated to MSs using uplink resources belonging to the group. In place of an uplink MAP (UL-MAP) Information Element (IE) in a message required to periodically allocate fixed uplink resources to MSs, one burst block allocation IE is used.

The present invention provides a message indicating a group of MSs to which one large burst block is allocated for resource allocation in the communication system and indicating MSs of a specific group to which one large burst block is allocated. In the present invention as described below, resources are allocated to reduce overhead of a UL-MAP IE included in a UL-MAP message for reporting resource allocation to an MS using a fixed size of uplink resource allocation in a fixed period. A Base Station (BS) groups MSs receiving the same service, for example, the same UGS, among the real-time services, allocates one large burst block to the group, and allocates data bursts of the burst block to the MSs using the UGS.

The above-describe message indicating a group of MSs to which one large block is allocated for resource allocation in the communication system and indicating MSs of a specific group to which one large block is allocated will be described when resources are allocated in the communication system in accordance with the present invention.

In the present invention, there are defined a Dynamic Service Addition Request (DSA-REQ) message for requesting a real-time service, for example, the UGS or rtPS, in the MS, a Dynamic Service Addition Response (DSA-RSP) message to be transmitted by the BS in response to the DSA-REQ message, and a DSA-REQ message to be first transmitted from the BS for directly setting the UGS or rtPS with the MS. In the present invention, the DSA-REQ message of the MS and the DSA-RSP and DSA-REQ messages of the BS include a Type/Length/Value (TLV) encoding format as shown in Tables 11 and 12. This message format can be applied to all Dynamic Service Change (DSC) procedures. Of course, the message format can be applied even when connection information of the preset UGS and rtPS is to be corrected.

When a connection for the real-time services of the UGS and rtPS and the like is set up in the present invention, block group IDentifier (ID) TLV encoding as shown in Tables 11 and 12 is contained in the DSA-REQ and DSA-RSP messages to allocate a specific sub-burst within a specific burst block.

TABLE 11

| Type | Length | Value | Scope |
|---|---|---|---|
| [145/146].x | Variable | Compound | DSx-REQ/RSP |

As shown in Table 11, the TLV encoding is contained in the DSA-REQ and DSA-RSP messages to register an MS desiring the real-time service of the UGS or rtPS in a specific burst block group and allocate a specific sub-burst to the MS within the group. The block group ID TLV encoding as shown in Table 11 includes parameters indicating a specific burst block ID and a specific sub-burst ID. The parameters used in the block group ID TLV encoding can be expressed as shown in Table 12.

TABLE 12

| Type | Length | Value |
|---|---|---|
| [145/146].x.1 | 1 | Burst Block Group ID |
| [145/146].x.2 | 1 | Sub-Burst Offset |
| [145/146].x.3 | 1 | Sub-Burst Duration |
| [145/146].x.4 | 1 | Repetition Coding Indication |
| [145/146].x.5 | 1 | MCS level (or UIUC) |

As shown in Table 12, Burst Block Group ID is that of a burst block allocated to the MS among the parameters used in the block group ID TLV encoding. In other words, Burst Block Group ID indicates an associated burst block when MSs, for example, for receiving the UGS or rtPS, in the same service scheduling are grouped into one group and data of the MSs of the group is transmitted in one burst block.

Among the parameters, Sub-Burst Offset can be used for an ID of a sub-burst allocated to an MS to be identified within a burst block of an associated burst block group. Like the duration parameter of Table 2, Sub-Burst Duration indicates a fixed size of data bursts in an associated connection, for example, the duration of an OFDMA slot unit. Repetition Coding Indication is the same parameter as that of Table 2.

Among the parameters, MCS Level indicates a Modulation and Coding Scheme (MCS) to be used when the MS transmits data in an allocated sub-burst. In the MCS Level parameter, an MCS level value predefined between the MS and the BS can be transmitted and an Uplink Interval Usage Code (UIUC) value can be used for Uplink Channel Descriptor (UCD) information to be transmitted in a UCD message between the BS and MSs. The type of value to be used depends on implementation. Since the type of value to be used is not directly related to the present invention, a description is omitted. The MCS level encoding can be omitted in implementation. In this case, the MCS level can be included in a burst block allocation IE as described below with reference to Table 13.

Two cases can be considered. First, when the MCS level is known in advance in the connection setup step, a size of the burst block allocation IE decreases but a variation in a channel state cannot be accepted. In contrast, when the MCS level is reported in a burst block allocation IE rather than in the connection setup step, a size of the burst block allocation IE increases but a variation in a channel state can be accepted to a certain degree. Preferred embodiments of the present invention can be applied to both cases. Preferably, this application can be adopted according to system implementation.

On the other hand, MSs using the same burst block can have the same data burst size and the same MCS level.

The MS can detect a position of a data burst corresponding to its own uplink resource using a combination of at least one parameter, for example, four or five parameters as described below. The parameters can be used in a format different from the TLV format.

A message as shown in Table 13, that is, a new burst block allocation IE, can be defined to allocate a burst block to MSs connected to the BS for scheduling the UGS and rtPS in the DSA process and to allocate data sub-bursts within the burst block.

TABLE 13

| Syntax | Size (bits) | Notes |
|---|---|---|
| Burst Block Allocation IE( ) { | | |
| Extended-2 UIUC | 4 | |
| Length | 8 | |
| Burst Block Group ID | 4 | |
| Block Duration | 10 | |
| MCS Level (or UIUC) | 4 | |
| Length of Sub-Burst Bitmap | 8 | |
| Sub-Burst Bitmap | Variable | |
| } | | |

As shown in Table 13, Burst Block Allocation IE can be defined as IEs to be used when the UIUC value of Table 2 is 11. That is, Burst Block Allocation IE can be contained in a UL-MAP message in an extension form of the UL-MAP IE. Of course, the Burst Block Allocation IE can be provided in a form capable of being detected between a BS and an MS, that is, in a modified form different from an extension form of the UL-MAP IE.

Extended-2 UIUC is used to distinguish extended IEs of the UL-MAP IE. That is, a specific value is allocated to identify Burst Block Allocation IE. In Table 13, the Length parameter indicates the length of a message below the Length parameter of Burst Block Allocation IE. Burst Block Group ID is that allocated to the MS as in Table 12.

Block Duration is used to indicate the end of a block, that is, a size of a block in an OFDMA slot unit, like Duration of Table 2. In the present invention, the block size has been described as the block duration in a one-dimensional allocation process. As in UIUC=12 in Table 12, a block position and size can be allocated in two dimensions using OFDMA Symbol Offset, Subchannel Offset, No. OFDMA Symbols and No. Subchannels. Of course, Block Duration can be omitted according to system setting. The burst block size can be estimated by multiplying a Sub-Burst Duration value of Table 12 by a value computed by counting the number of bits set to 1 by referring to Sub-Burst Bitmap as described below.

MSs to which the same block group ID is allocated decode the above-described Burst Block Allocation IE. Each of the MSs detects whether its own sub-burst is present within the burst block. For this, Sub-Burst Bitmap is used as shown in Table 13. Sub-Burst Bitmap is used to indicate which MS is assigned a sub-burst among the MSs to which the same block group ID is allocated. As described with reference to Table 12, each MS for receiving the UGS and rtPS is assigned not only a block group ID but also a sub-burst offset. The sub-burst offset can be used for a logical ID of a sub-burst within the block allocated to the MS.

In other words, the 0^{th} bit from a Most Significant Bit (MSB) of Sub-Burst Bitmap of Burst Block Allocation IE is allocated to an MS to which Sub-Burst Offset of 0 is allocated. The MS to which the 0^{th} bit is allocated checks the 0^{th} bit from the MSB. For example, the MS to which Sub-Burst Offset of 7 is allocated checks the 7^{th} bit from the MSB.

When an associated bit checked by the MS is set to 1, the MS can determine that the BS has allocated an uplink resource, that is, a data sub-burst, within an associated burst block, for the MS. Thus the MS can detect its own sub-burst from the associated burst block. For this, the MS checks Sub-Burst Bitmap of Table 13 and then counts the number of bits set to 1 before the associated bit allocated to itself.

In other words, sub-bursts are allocated only to MSs using data sub-bursts within a burst block in a sequence of Sub-Burst Offsets as shown in Table 12. In Sub-Burst Bitmap of Table 13, bits of MSs to which the data sub-bursts are allocated are set to 1.

Thus an MS for which the associated bit is set to 1 in Sub-Burst Bitmap counts the number of sub-bursts allocated to other MSs with Sub-Burst Offset values smaller than its own value, that is, counts the number of bits set to 1 before its own bit, and checks a sequence number of its own sub-burst.

For example, it is assumed that a UL-MAP message contains Burst Block Allocation IE for a block in which Burst Block Group ID is 0 and Sub-Burst Bitmap is 1001001100. An MS for which Burst Block Group ID is 0 and Sub-Burst Offset is 7 determines that there is a burst block mapped to its own allocated Burst Block Group ID and additionally checks a parameter of Burst Block Allocation IE.

That is, the MS first determines whether the 7^{th} bit mapped to its own Sub-Burst Offset 7 is set to 1 in Sub-Burst Bitmap. When the 7^{th} bit is set to 1, the MS determines that its own sub-burst is allocated. When determining that the sub-burst is allocated, the MS counts the number of bits set to 1 before the 7^{th} bit to check a sequence number of its own sub-burst within the block.

When a total of three bits (for example, the 00h, 3^{rd} and 6^{th} bits) set to 1 are counted before the 7^{th} bit of the MS, the MS determines that the 4^{th} sub-burst is allocated for itself. A start point and size of the 4^{th} sub-burst can be detected from Sub-Burst Duration as described with reference to Table 12. That is, since Sub-Burst Durations allocated to MSs within one block have the same size, the 4^{th} sub-burst starts after an OFDMA slot of 3*Sub-Burst Duration from the start point of the block and its size is Sub-Burst Duration.

MCS Level of Table 13 to be used when data is transmitted in a sub-burst allocated to an MS can be omitted as described with reference to Table 12. Since MCS Level has been described with reference to Table 12, a description is omitted.

On the other hand, Burst Block Allocation IE is positioned subsequent to other UL-MAP IEs within the UL-MAP message. This is because MSs incapable of detecting Burst Block Allocation IE are assigned a burst of an uplink sub-frame in a one-dimensional allocation method, respectively. Of course, a bit can be allocated from a Least Significant Bit (LSB) in Burst Block Allocation IE. The MS can count the number of bits set to 1 after its own allocated bit and can equally apply the above-described process.

When Burst Block Allocation IE is positioned in the front or middle of the UL-MAP IE, the MS does not detect the presence of a burst block and the size and position of the burst block, such that the burst block collides with a burst region of the UL-MAP IE. That is, the burst block overlapping with the burst region of the UL-MAP IE may be used. To prevent the collision or overlap, a UL-MAP IE including Burst Block Allocation IE can be preferably positioned in the last UL-MAP IE, that is, at the rear of the existing UL-MAP IE.

However, the present invention is not limited to the above-described position of the UL-MAP IE. If the existing MSs can detect and decode Burst Block Allocation IE, Burst Block Allocation IE can be randomly mixed with the existing UL-MAP IE. In this case, the MS can perform decoding in order of the existing UL-MAP IE and Burst Block Allocation IE.

Next, fixed size uplink resource allocation periodically performed in real-time services, for example, the UGS and rtPS, in accordance with an preferred embodiment of the present invention will be described in detail.

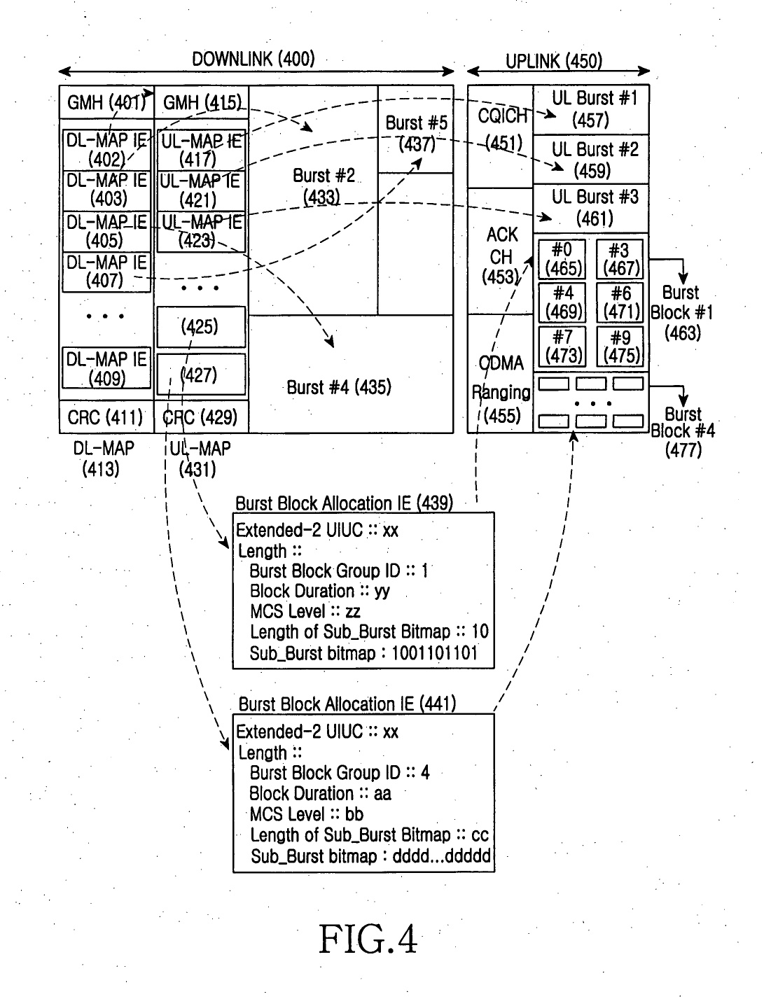

FIG. 4 shows a frame structure in a communication system in accordance with the present invention. In particular, FIG. 4 shows a frame structure based on, for example, a Time Division Duplex (TDD) scheme, in the communication system.

Referring to FIG. 4, a downlink frame 400 and an uplink frame 450 are sequentially included on the time axis in the communication system in accordance with the present invention. In the downlink frame 400 or its front end, a Frame Control Header (FCH) and a preamble are positioned. Since the FCH and the preamble are not directly related to the present invention, a description is omitted.

The downlink frame 400 includes a DL-MAP message 413, a UL-MAP message 431 and data bursts 433, 435 and 437.

The DL-MAP message 413 notifies MSs of a position, size and attribute of control information and data traffic to be transmitted in a downlink frame. The DL-MAP message 413 contains a Generic Medium Access Control (MAC) Header (GMH) 401, DL-MAP IEs 402, 403, 405, 407 and 409, a Cyclic Redundancy Check (CRC) field 411, and the like. The GMH 401 is a MAC header for MAC data, that is, the DL-MAP IEs 402, 403, 405, 407 and 409.

The CRC field 411 indicates a CRC result value for the GMH 401 and the MAC data.

The DL-MAP IEs 402, 403, 405, 407 and 409 contain information regarding uplink bursts, that is, uplink resources 415, 433, 435 and 437, in which data is transmitted to a single MS or multiple MSs in the uplink frame 400. A burst indicated by the first DL-MAP IE 402 includes the UL-MAP message 413. Since the CRC field 411, the GMH 401 and the DL-MAP IEs 402, 403, 405, 407 and 409 are not directly related to the present invention, a description is omitted.

Like the DL-MAP message 413, the UL-MAP message 431 within a burst region indicated by the first DL-MAP IE 402 includes a GMH 415, a CRC field 429 and multiple UL-MAP IEs 417, 421, 423, 425 and 427. In accordance with the present invention, the burst block allocation IEs 425 and 427 are contained in the UL-MAP message 431. The UL-MAP IEs 417, 421 and 423 are used to allocate uplink resources such that MSs can transmit data in uplink frames. That is, the UL-MAP IEs 417, 421 and 423 indicate uplink bursts.

An uplink frame 450 includes a Channel Quality Indication Channel (CQICH) field 451 for a channel used to transmit Channel Quality Indication (CQI) information of a BS measured by an MS, an ACKnowledge CHannel (ACKCH) field 453 for a channel used to transmit feedback/acknowledge information and the like, and a CDMA ranging field 455 for initial ranging or periodic ranging and bandwidth request. Since these fields are defined and indicated in the UL-MAP IE as described with reference to Table 2, a description is omitted.

Next, the burst block allocation IEs in the communication system in accordance with the present invention will be described.

As described with reference to Tables 12 and 13, the burst block allocation IEs 425 and 427 are used to reduce overhead of the UL-MAP IE contained in the UL-MAP message. That is, the BS uses the burst block allocation IEs 425 and 427 in order to group MSs for receiving the same real-time services, for example, the UGS, the rtPS and the like, allocate one burst block to each group and allocate data bursts to the MSs using the real-time services within the burst block.

To report data bursts allocated to the MSs for receiving the same real-time service, the BS includes the burst block allocation IEs 425 and 427 in the UL-MAP message 431. Preferably, the burst block allocation IEs 425 and 427 can be positioned subsequent to the last UL-MAP IE 423 for the MSs for receiving the existing service, for example, the MSs incapable of detecting the burst block allocation IEs, in accordance with the present invention.

When MSs receives allocated burst blocks 463 and 477 among MSs for receiving the real-time service, that is, the MSs are mapped to a block group in block group ID TLV encoding as described with reference to Table 12 in a DSA-REQ/RSP process, the MSs retrieve a UL-MAP IE and a burst block allocation IE from the UL-MAP message 431, respectively.

More specifically, the MSs mapped to the block group first check a burst block group ID included in the burst block allocation IEs 439 and 441. If the burst block group ID is different from that allocated in the DSA-REQ/RSP process, an MS discards a received burst block since the received burst block is not its own burst block. However, if the burst block group ID within the burst block allocation IEs 439 and 441 is the same as that allocated to the MS, the MS determines whether its own sub-burst is present within the burst block.

For this, the MS checks a sub-burst bitmap within the burst block allocation IEs 439 and 441 as described with reference to Table 13. First, the MS determines whether its own sub-burst offset is included in a ‘Length of Sub-Burst Bitmap’ range within the burst block allocation IEs 439 and 441.

If the sub-burst offset of the MS is determined to be absent in the ‘Length of Sub-Burst Bitmap’ range, any sub-burst of the burst block is not allocated to the associated MS. Thus the MS no longer needs to decode the burst block allocation IEs 439 and 441.

However, if the sub-burst offset of the MS is determined to be present in the ‘Length of Sub-Burst Bitmap’ range, the MS determines whether its own sub-burst is allocated within the burst blocks 463 and 477. That is, the MS checks its own bit allocated in a sub-burst bitmap as described with reference to Table 13. When the bit is set to 1, a sub-burst for the MS is allocated. The MS decodes its own sub-burst in the associated burst blocks 463 and 477.

The MS counts the number of sub-bursts allocated to other MSs with sub-burst offset values smaller than its own value in order to retrieve a position of its own sub-burst from the burst blocks 463 and 477 as described with reference to Table 13. That is, the MS counts the number of bits set to 1 before its own bit and checks a sequence number of its own sub-burst. The MS provides the BS with data using its own sub-burst within the burst blocks 463 and 477.

Referring to FIG. 4, every MS decodes the UL-MAP IEs 417, 421 and 423 within the UL-MAP message 431 in order to determine whether its own uplink burst is allocated. In the DSA-REQ/RSP process, MSs mapped to an arbitrary burst block group in block group ID TLV encoding additionally check the burst block allocation IEs 425 and 427 of the UL-MAP message 431. When an associated MS is assigned a burst block group ID of 1 in a burst block allocation IE 439, the MS determines that its own burst block allocation IE is allocated. That is, the MS continuously decodes its own burst block allocation IE of the burst block allocation IEs 425 and 427, for example, the burst block allocation IE 439.

Since a value of a ‘Length of Sub-Burst Bitmap’ parameter of the burst block allocation IE 439 is 10, an MS for which a ‘Sub-Burst Offset’ parameter is more than 10 is not assigned a sub-burst and does not decode the burst block allocation IE 439. In contrast, MSs for which ‘Length of Sub-Burst Bitmap’ parameters have values of 0 to 9 check ‘Sub-Burst Bitmap’ parameters to determine whether their own allocated sub-bursts are present in the block.

If Sub-Burst Bitmap is 1001101101 in the sub-burst allocation IE 439, sub-bursts 465, 467, 469, 471, 473 and 475 of the burst block 463 are sequentially allocated for an MS with Sub-Burst Offset=0, an MS with Sub-Burst Offset=3, an MS with Sub-Burst Offset=4, an MS with Sub-Burst Offset=6, an MS with Sub-Burst Offset=7 and an MS with Sub-Burst Offset=9. Thus the MS with Sub-Burst Offset=0, 3, 4, 6, 7 or 9 checks its own sub-burst position using a ‘Sub-Burst Duration’ parameter within block group ID TLV encoding negotiated in the DSA-REQ/RSP process and then provides the BS with data through a sub-burst of the MS. In this case, a used MCS level of the MS is determined by referring to a value of a ‘MCS Level’ parameter of the burst block allocation IE 439.

The used frame structure and the burst block/sub-burst allocation method in the communication system in accordance with the present invention have been described with reference to FIG. 4. Next, the operations of the MS and the BS in the communication system in accordance with an preferred embodiment of the present invention will be described.

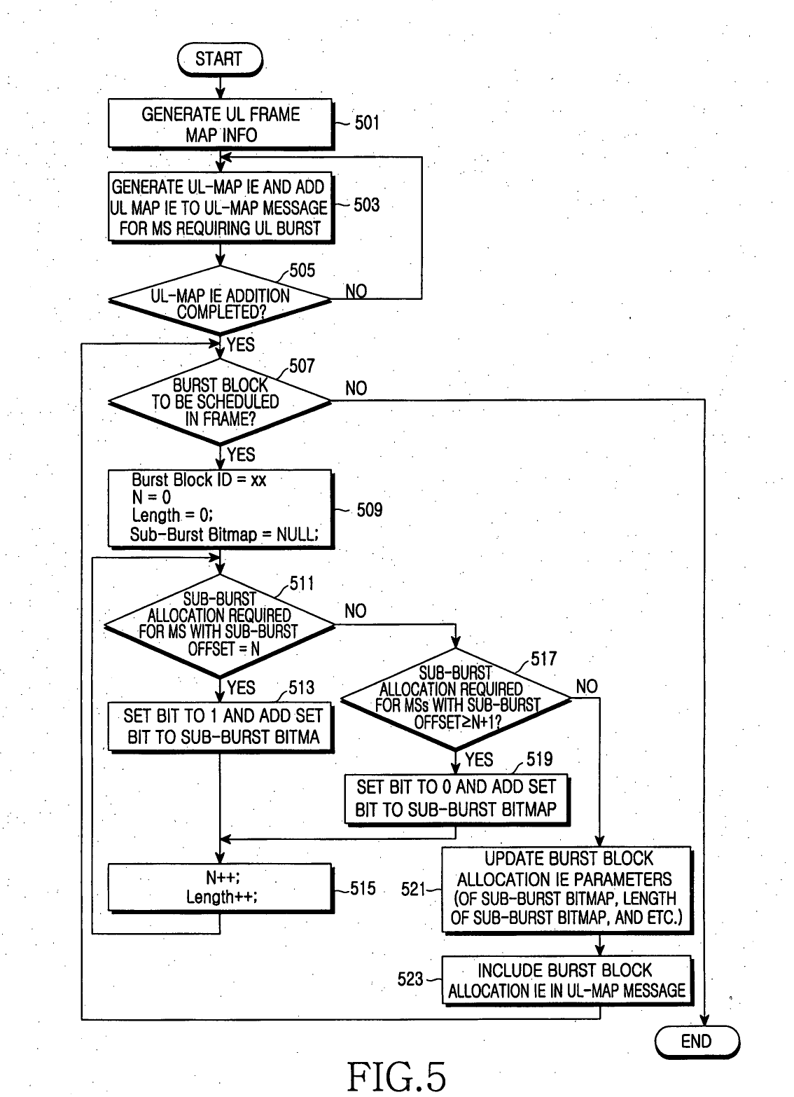

FIG. 5 shows a data burst allocation process for a real-time service in the communication system in accordance with the present invention. In particular, FIG. 5 shows an operation in which a BS generates a burst block allocation IE and includes the generated burst block allocation ID in a UL-MAP message in order to group MSs for receiving the real-time services, for example, the UGS, the rtPS and the like, allocate one large burst block to each group and allocate data bursts to the MSs for the real-time services within the burst block in the communication system in accordance with the present invention. The BS notifies MSs of burst allocation information in every (uplink/downlink) frame. For this, the BS generates DL-MAP and UL-MAP messages as described with reference to FIG. 4 in every frame and then broadcasts the generated messages to the MSs. In particular, FIG. 5 illustrates an operation in which the BS generates a burst block allocation IE and includes the generated burst block allocation IE in the UL-MAP message when notifying the MSs of uplink burst allocation information.

Referring to FIG. 5, the BS generates UL-MAP message information for a subsequent uplink frame, that is, UL-MAP IEs, in step 501. Then the BS adds the generated UL-MAP IEs to the UL-MAP message to schedule MSs using uplink bursts in step 503. That is, the BS generates the UL-MAP IEs for the associated MSs and includes the generated UL-MAP IEs in the UL-MAP message to notify the associated MSs using the uplink bursts of uplink burst allocation, and then proceeds to step 505.

In step 505, the BS determines whether there are any more MSs to which uplink bursts are allocated. If it is determined that there are no more MSs to which uplink bursts are allocated in step 505, that is, when UL-MAP IE addition is completed, the BS proceeds to step 507. When the UL-MAP IE addition is completed, the BS proceeds to step 507 to allocate a burst block through a burst block allocation IE as described with reference to Tables 12 and 13.

If it is determined that there are any more MSs to which uplink bursts are allocated in step 505, that is, an additional scheduling process for MSs using uplink bursts is used, the BS proceeds to step 503 to add a UL-MAP IE of an associated MS to the UL-MAP message.

In step 507, the BS determines whether there is a burst block to be scheduled in an associated frame. That is, in step 507, the BS determines whether a scheduling process is used for a service, that is, the burst block, for grouped MSs as described with reference to Tables 12 and 13 among MSs for performing a real-time service in an associated uplink frame. Upon determining that the scheduling process is used for the burst block in step 507, the BS proceeds to step 509.

If there is the burst block to be scheduled, the BS prepares/sets parameters for constructing an associated burst block allocation IE in step 509. That is, in step 509, the BS prepares/sets parameters of Burst Block ID, N, Length, Sub-Burst Bitmap and the like.

For example, in step 509, Burst Block ID is set to xx and N is initialized which corresponds to an index used to identify the presence of sub-burst allocation according to sub-burst offsets of MSs. That is, N serving as a parameter used to check the length of a sub-burst bitmap indicating the presence of sub-burst allocation is initialized to 0. The sub-burst bitmap is used to indicate the presence of sub-burst allocation in bit form. In an initial state, no bit is allocated. The BS initializes the parameters and then proceeds to step 511.

In step 511, the BS determines whether sub-burst allocation for an MS with Sub-Burst Offset=N is used. If a sub-burst is to be allocated to an associated burst block in step 511, the BS proceeds to step 513. Since a sub-burst is to be allocated to the associated burst block, an associated bit separated by an associated sub-burst offset from the MSB as described with reference to Table 12 is set to 1 in a method for reporting allocation for the associated burst block in the BS in step 513. The BS sets the associated bit to 1 and adds the set bit to a current sub-burst bitmap. After the associated bit is added, the BS proceeds to step 515. In step 515, the BS increments N by 1 to determine whether sub-burst allocation for the next sub-burst offset is used. As the length of the sub-burst bitmap is incremented by 1 in step 513, the BS increments a ‘Length’ parameter by 1 in step 515. Then the BS returns to step 511 to determine whether there is an MS with the next sub-burst offset using a sub-burst.

Upon determining that an MS with Sub-Burst Offset=N does not use a sub-burst in step 511, the BS proceeds to step 517. In step 517, the BS determines whether there is an MS using a sub-burst among MSs with Sub-Burst Offset ≧N+1.

Upon determining that there is at least one MS using a sub-burst in step 517, the BS proceeds to step 519. The BS sets the associated bit to 0 and adds the set bit to the sub-burst bitmap in step 519 as in step 513 and then proceeds to step 515. The bit is set to 0 since there may be an MS having the sub-burst offset to be set to 1.

Upon determining that a sub-burst does not need to be allocated to MSs with Sub-Burst Offset ≧N+1 in step 517, the BS proceeds to step 521. The BS updates a burst block allocation IE using the already set parameters of ‘Sub-Burst Bitmap’ and ‘Length of Sub-Burst Bitmap’ (into which an N value is substituted) in step 521 and then proceeds to step 523. In step 523, the BS adds the burst block allocation IE updated and generated in step 521 to the UL-MAP message. Then the BS proceeds to step 507 to determine whether a scheduling process for another burst block is used.

Upon determining that the scheduling process for another burst block is not used in step 507, the BS ends an operation for adding an IE to the UL-MAP message since an operation for including a burst block allocation IE for a burst block and a UL-MAP IE in the associated UL-MAP message is completed.

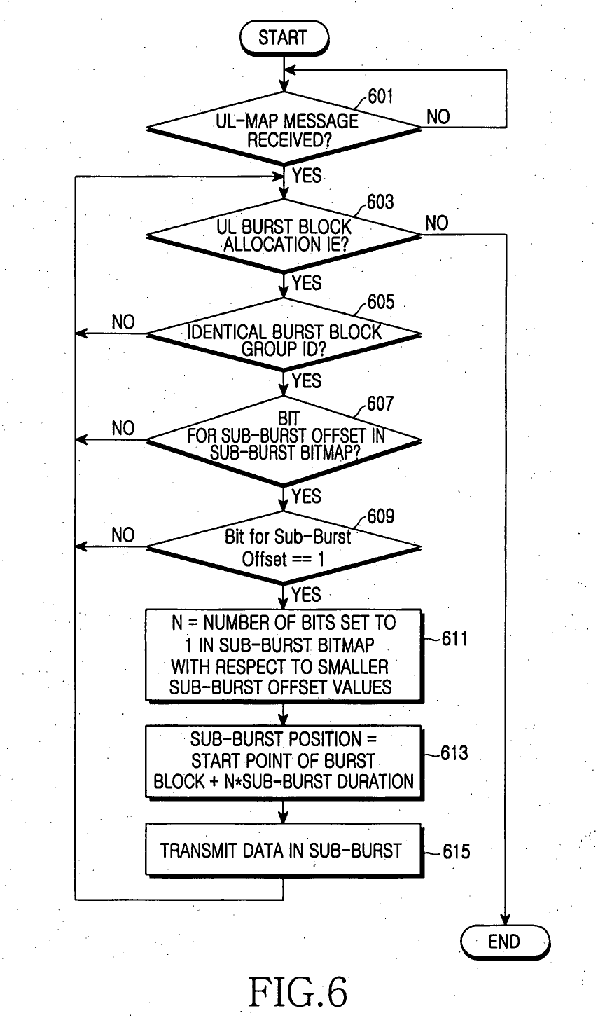

FIG. 6 shows an operation of an MS for uplink scheduling of a real-time service in the communication system in accordance with the present invention. In particular, FIG. 6 shows an operation in which the MS transmits data by detecting its own sub-burst position in a burst block in the communication system. MSs for which connections for scheduling a real-time service, for example, the UGS or rtPS, are set up check a general UL-MAP IE and check their own burst blocks and their own sub-bursts. In other words, when the UL-MAP message is received by MSs for which connections are set up, particularly, MSs to which parameters defined in Tables 12 and 13, for example, Burst Block Group ID, Sub-Burst Offset, Sub-Burst Duration and Repetition Coding Indication, are allocated, the MSs check a UL-MAP IE and identify the presence of their own burst block and an associated sub-burst of the burst block. In particular, FIG. 6 shows an operation in which an MS checks an associated burst block in a UL-MAP message and a sub-burst within the burst block.

Referring to FIG. 6, the MS determines whether a UL-MAP message is received in step 601. Upon determining that the UL-MAP message is received in step 601, the MS proceeds to step 603. If the UL-MAP message is not received, the MS returns to step 601 to receive the UL-MAP message.

In step 603, the MS determines whether a burst block allocation IE is included in the received UL-MAP message. The burst block allocation IE is used to define a burst block provided from the BS to MSs for receiving the UGS or rtPS as described with reference to Table 13.

If the uplink burst block allocation IE is determined to be absent in step 603, the MS ends an operation of the present invention. The MS can perform not only the operation provided in the present invention but also an operation for processing an existing UL-MAP IE. That is, the two operations do not have an exclusive relation but a service of the MS is scheduled using both the two operations.

If the uplink burst block allocation IE is determined to be present within the UL-MAP message in step 603, the MS proceeds to step 605. In step 605, the MS determines whether a burst block group ID of a burst block indicated in the burst block allocation IE is equal to that allocated to the MS, that is, an ID of a group to which the MS currently belongs. That is, the MS determines whether there is a burst block for the MS.

If the two burst block group IDs are determined to be identical in step 605, the MS proceeds to step 607. In step 607, the MS determines whether a sub-burst offset bit is allocated in a sub-burst bitmap indicating sub-burst allocation. That is, the MS determines whether a bit mapped to a sub-burst offset of the MS is present in the sub-burst bitmap indicating sub-burst allocation within the received burst block in step 607. In other words, the MS determines whether a ‘Length of Sub-Burst Bitmap’ parameter of the burst block allocation IE includes a bit mapped to the sub-burst offset of the MS.

If the bit mapped to the sub-burst offset of the MS is determined to be present in step 607, the MS proceeds to step 609. In step 609, the bit mapped to the sub-burst offset of the MS is checked. Upon determining that the bit mapped to the sub-burst offset of the MS is set to 1, the MS proceeds to step 611. In step 611, the MS determines that its own sub-burst is allocated since the bit for the sub-burst offset of the MS is set to 1. The MS proceeds to step 613 to compute a position of a sub-burst within the block.

The MS checks its own sub-burst position as described with reference to Table 13 in step 613 and then proceeds to step 615. That is, the MS counts the number of bits set to 1 among bits mapped to other MSs with sub-burst offset values smaller than a sub-burst offset value of the MS in step 613. The MS checks its own sub-burst position through the counting operation and then proceeds to step 615.

In step 615, the MS transmits uplink data in a sub-burst of an associated burst block at an MCS level as described with reference to Tables 12 and 13. Then the MS returns to step 603 to determine whether another uplink burst block allocation IE is present in the UL-MAP message. This means that one MS has multiple UGS or rtPS connections.

Upon determining that the burst block group ID of the burst block allocation IE is different from that of the MS in step 605, the MS returns to step 603 to retrieve another burst block allocation IE from the UL-MAP message. If the bit mapped to the sub-burst offset of the MS is determined to be absent in step 607, the MS returns to step 603 to retrieve another burst block allocation IE.

A procedure in which an MS with a UGS or rtPS connection checks sub-burst allocation in a burst block of the present invention has been described with reference to FIG. 6. Since the present invention performs a burst allocation method using an existing UL-MAP IE without replacing an operation for processing the existing UL-MAP IE as described above, uplink resources can be effectively used. The efficiency of uplink resource use can be improved by addressing a problem occurring in an existing operation while maintaining the compatibility with an existing operation scheme.

Next a scheme for providing parameter information for a burst block in UCD information will be described. That is, a scheme for notifying the MS of parameter information for an associated burst block in a UCD message whenever a connection for a real-time service of the UGS or rtPS is set up will be described.

First, information to be newly added to the UCD message in the communication system in accordance with the present invention will be described.

A BS broadcasts information regarding multiple burst blocks in the UCD message in the communication system in accordance with the present invention. The BS includes and transmits multiple burst block profiles in the UCD message like uplink burst profiles in the UCD message.

Information to be contained in the UCD message periodically broadcast in the communication system in accordance with the present invention can be expressed as shown in Table 14.

TABLE 14

| Type | Length | Value | Scope |
|---|---|---|---|
| 151.x | Variable | Compound | UCD |

As shown in Table 14, the UCD message contains a burst block profile. The burst block profile includes parameters indicating a specific burst block ID and a specific sub-burst ID. The parameters to be used in the burst block profile can be expressed as shown in Table 15.

TABLE 15

| Type | Length | Value |
|---|---|---|
| 151.x.1 | 1 | Burst Block Group ID |
| 151.x.2 | 1 | Sub-Burst Duration |
| 151.x.3 | 1 | Repetition Coding Indication |
| 151.x.4 | 1 | MCS level (or UIUC) |

The parameters of Table 15 are the same as those of Table 12. Table 15 excludes Sub-Burst Offset, which is different from Table 12. In Table 15, an ‘MCS Level’ parameter can be omitted in implementation as described with reference to Table 12. The ‘MCS Level’ parameter can be included in a burst allocation IE as described with reference to Table 13.

On the other hand, the BS periodically provides MSs with the burst block profile as shown in Table 15 in multiple UCD messages.

Next a DSx-RSP or DSx-REQ message to be transmitted from the BS in the communication system in accordance with the present invention will be described.

When a connection for a real-time service, for example, the UGS or rtPS, is set up as described above, DSA-REQ and DSA-RSP messages contain block group ID TLV encoding as shown in Table 16 to allocate a specific sub-burst of a specific burst block to an MS.

TABLE 16

| Type | Length | Value | Scope |
|---|---|---|---|
| [145/146].x | Variable | Compound | DSx-REQ/RSP |

As shown in Table 16, the TLV encoding includes parameters indicating a specific burst block ID and a specific sub-burst ID. The parameters used in the block group ID TLV encoding can be expressed as shown in Table 17.

TABLE 17

| Type | Length | Value |
|---|---|---|
| [145/146].x.1 | 1 | Burst Block Group ID |
| [145/146].x.2 | 1 | Sub-Burst Offset |

The parameters used in the block group ID TLV encoding as shown in Table 17 are the same as described in Table 12. That is, the burst block group ID is that of a burst block allocated to an MS. A ‘Sub-Burst Offset’ parameter is used to identify an MS in an associated burst block group. That is, the ‘Sub-Burst Offset’ parameter is used as an ID of a sub-burst of the burst block allocated to the MS.

In the communication system in accordance with the present invention, a UL-MAP IE can use the same burst block allocation IE as described with reference to Table 12. To reduce a size of a message, parameters of ‘Block Duration’ and ‘MCS Level’ as described above can be omitted. Since this operation is the same as described with reference to Table 12, a description is omitted.

As is apparent from the above description, the present invention can periodically allocate fixed uplink resources to multiple MSs by grouping MSs using a real-time service, for example, the UGS or rtPS, allocating one burst block and allocating sub-bursts of the burst block to the MSs using the uplink resources in communication system. Moreover, the present invention can reduce message overhead by employing one burst block allocation IE in place of messages constantly used to allocate the resources. Moreover, the present invention can increase the use efficiency of uplink resources by reducing the message overhead and can be compatible with an existing system by employing an existing UL-MAP IE.

While the invention has been shown and described with reference to certain preferred embodiments of the present invention thereof, it will be understood by those skilled in the art that various changes in form and details may be made therein without departing from the spirit and scope of the present invention as defined by the appended claims and their equivalents.

What is claimed is:

1. A method for transmitting and receiving data in a communication system, the method comprising:
grouping, by a Base Station (BS), Mobile Stations (MSs) using a real-time service, into groups, allocating burst blocks to the groups, and allocating data bursts of burst blocks to the MSs; and
determining, by each MS, whether its own uplink burst is allocated, and transmitting data to the BS through a sub-burst of a burst block allocated to a group to which each MS belongs.

2. The method of claim 1, wherein the real-time service comprises at least one of an Unsolicited Grant Service (UGS), a real-time Polling Service (rtPS), and an extended real-time Polling Service (ertPS).

3. The method of claim 1, wherein the grouping comprises grouping MSs using an identical real-time service into one group.

4. The method of claim 1, wherein the allocating the data bursts comprises allocating sub-bursts within the burst block.

5. The method of claim 1, wherein a connection for the real-time service is set up in a process for transmitting and receiving a Dynamic Service Addition Request message and a Dynamic Service Addition Response message between the BS and a MS, the Dynamic Service Addition Request message and the Dynamic Service Addition Request message comprising Type/Length/Value (TLV) encoding for indicating a burst block IDentifier (ID) and a sub-burst ID.

6. The method of claim 5, wherein the TLV encoding comprises a burst block group ID field for indicating an ID of a burst block allocated to an MS, and a sub-burst offset field for identifying a MS in a burst block group.

7. The method of claim 6, wherein the TLV encoding further comprises a sub-burst duration field for indicating a fixed size of data bursts in the connection between the BS and the MS, a repetition coding indication field for indicating a repetition of coding to be used, and at least one of an Uplink Interval Usage Code (UIUC) field and a Modulation and Coding Scheme (MCS) level field for indicating a MCS level to be used when the MS transmits data in an allocated sub-burst.

8. The method of claim 6, wherein the burst block group ID field indicates the burst block when the M Ss using an identical real-time service are grouped into one group and data is transmitted to the MSs of the group through one burst block.

9. The method of claim 6, wherein the sub-burst offset field indicates an ID of a sub-burst allocated to the M S in the burst block.

10. The method of claim 7, wherein the sub-burst duration field indicates a duration of an Orthogonal Frequency Division Multiple Access (OFDMA) slot unit.

11. The method of claim 7, wherein the B S transmits a value of the MCS level defined between the B S and the Mobile S through the field of the TLV encoding.

12. The method of claim 7, wherein the B S transmits a UIUC value of an Uplink Channel Descriptor (UCD) message through the field of the TLV encoding.

13. The method of claim 7, wherein the MCS level is omitted in the TLV encoding and is comprised and transmitted in a burst block allocation information element.

14. The method of claim 7, wherein the MS detects a position of a data burst serving as an uplink resource allocated to itself using a combination of at least one of the TLV encoding fields.

15. The method of claim 1, wherein the BS uses a burst block allocation information element to periodically allocate fixed uplink resources to the MSs.

16. The method of claim 15, wherein the burst block allocation information element is information for allocating the burst block to the MSs connected to the BS and allocating sub-bursts within the burst block.

17. The method of claim 15, wherein the burst block allocation information element is comprised in an uplink MAP message.

18. The method of claim 15, wherein the burst block allocation information element comprises an extended-2 Uplink Interval Usage Code (UIUC) field for distinguishing extended information elements of an uplink MAP information element, a length field for indicating a message length of the burst block allocation information element, a burst block group IDentifier (ID) field for indicating a burst block group ID allocated to the MSs, a block duration field for indicating an end of the burst block, a length of sub-burst bitmap field for indicating a length of a sub-burst bitmap, and a sub-burst bitmap field for indicating which MS is assigned a sub-burst among the MSs to which an identical block group ID is allocated.

19. The method of claim 18, wherein the block duration field indicates a position and size of the burst block in at least one of one-dimensional allocation and two-dimensional allocation, and is omitted according to system setting.

20. The method of claim 18, wherein the block duration field indicates a size of the burst block in an Orthogonal Frequency Division Multiple Access (OFDMA) slot unit.

21. The method of claim 18, wherein the sub-burst offset field indicates a logical ID of a sub-burst of the burst block allocated to the MSs.

22. The method of claim 18, wherein a Modulation and Coding Scheme (MCS) level to be used when an MS transmits data in an allocated sub-burst is omitted.

23. The method of claim 15, wherein the burst block allocation information element is positioned at a rear of a last uplink MAP information element within an uplink MAP message.

24. The method of claim 15, wherein the burst block allocation information element is randomly positioned together with an uplink MAP information element within an uplink MAP message.

25. The method of claim 1, wherein each MS is assigned a block group IDentifier (ID) and a sub-burst offset from the BS.

26. The method of claim 25, wherein the BS allocates an N-th bit from a Most Significant Bit (MSB) of a sub-burst bitmap of a burst block allocation information element to an MS to which a sub-burst offset of N is allocated, the MS retrieving the N-th bit from the MSB of the sub-burst bitmap.

27. The method of claim 1, wherein the BS allocates sub-bursts to MSs using the sub-bursts of a burst block in a sequence of sub-burst offsets, and sets a bit for each MS to which a sub-burst is allocated to 1.

28. The method of claim 1, wherein the MSs further comprise determining that the Base Station has allocated a sub-burst of a burst block to the Mobile Stations when an N-th bit of a sub-burst bitmap is set to 1, identifying the sub-burst of the burst block allocated to the MSs from the sub-burst bitmap, counting the number of bits set to 1 before the bit allocated to the MSs, and checking a sub-burst position of the MSs using the counted number.

29. The method of claim 1, wherein MSs using a burst block allocated to an identical group among the burst blocks have the same data burst size as each other.

30. The method of claim 1, wherein MSs using a burst block allocated to an identical group among the burst blocks have the same Modulation and Coding Scheme (MCS) level as each other.

31. A method for transmitting and receiving data in a communication system, the method comprising:
generating, by a Base Station (BS), uplink MAP message information and adding the generated uplink MAP message information to an uplink MAP message;
determining whether there is a burst block to be scheduled in a frame when the uplink MAP message information is completely added;
generating and setting information for allocating data bursts of the burst block to Mobile Stations (MSs) when there is the burst block to be scheduled;
determining whether sub-burst allocation for the MSs is used in the burst block;
allocating sub-bursts of the burst block when the sub-burst allocation of the burst block is used;
determining whether sub-burst allocation for MSs with an offset or more is used when the sub-burst allocation of the burst block is not used;
allocating a sub-burst of the burst block when the sub-burst allocation for at least one MS is used; and
updating the information for allocating the data bursts when the sub-burst allocation for the MS is not used, adding the updated information to the uplink MAP message, and broadcasting the uplink MAP message to the MSs.

32. The method of claim 31, wherein the uplink MAP message information comprises an uplink MAP information element added to the uplink MAP message for scheduling of the MSs using uplink bursts.

33. The method of claim 32, wherein the uplink MAP message information element is information for notifying an associated MS using an uplink burst of uplink burst allocation.

34. The method of claim 31, wherein the adding to the uplink MAP message information is completed when there are no more MSs to which uplink bursts are allocated after determining whether there are any more MSs to which the uplink bursts are allocated.

35. The method of claim 31, wherein the determining whether there is a burst block to be scheduled comprises determining whether scheduling is used for a burst block allocated to grouped MSs among MSs for performing a real-time service in an uplink frame.

36. The method of claim 31, wherein the generating and setting the information for allocating the data bursts comprise generating and setting a burst block IDentifier (ID), an index for identifying sub-burst allocation according to sub-burst offsets of the Mstations, and a sub-burst bitmap for indicating the sub-burst allocation in a bit form.

37. The method of claim 31, wherein the determining whether the sub-burst allocation for the MSs is used comprises determining whether sub-burst allocation for MSs with a sub-burst offset of N is used.

38. The method of claim 31, wherein the allocating the sub-burst of the burst block comprises incrementing a length parameter mapped to an increase in a length of a sub-burst bitmap and a sub-burst offset of N allocated to an MS to determine whether sub-burst allocation for a next sub-burst offset is used after setting an associated bit separated by an associated sub-burst offset from a Most Significant Bit (MSB) of the sub-burst bitmap to 1 to notify an MS of the sub-burst allocation.

39. The method of claim 38, wherein the allocating the sub-burst of the burst block further comprises determining whether there is an MS with the next sub-burst offset using a sub-burst after incrementing the sub-burst offset and the length parameter.

40. The method of claim 31, wherein the determining whether the sub-burst allocation for the MSs with the offset or more is used comprises determining whether sub-burst allocation for an MS with a sub-burst offset of N is used, and determining whether there is an MS using a sub-burst among MSs with sub-burst offsets of N+1 or more when a sub-burst for the MS is not used.

41. The method of claim 31, wherein the allocating the sub-burst of the burst block when the sub-burst allocation for the MS is used comprises setting an associated bit to 0 and adding the set bit to a sub-burst bitmap.

42. The method of claim 31, wherein the updating the information for allocating the data bursts comprises updating a burst block allocation information element using a sub-burst bitmap and a parameter indicating a length of the sub-burst bitmap if sub-burst allocation for MSs with sub-burst offsets of N+1 or more is not used.

43. The method of claim 31, wherein the adding to the uplink MAP message comprises updating a burst block allocation information element, adding the updated burst block allocation information element to the uplink MAP message, and determining whether there is other burst blocks to be scheduled after adding the burst block allocation information element.

44. The method of claim 31, wherein the BS groups MSs for receiving an identical real-time service into one group, allocates one burst block to the group, generates a burst block allocation information element for allocating data bursts of the burst block to the MSs and comprises and transmits the generated element in an uplink message.

45. The method of claim 31, wherein the BS reports burst allocation information through a burst block allocation information element comprised in the uplink MAP message in every frame.

46. A method for transmitting and receiving data in a communication system, the method comprising:
receiving, by an Mobile Station (MS), an uplink MAP message from a Base Station (BS) and determining whether data burst allocation information is comprised in the uplink MAP message;
determining whether the data burst allocation information indicates a burst block for the MS when the data burst allocation information is determined to be present in the uplink MAP message;
determining whether a bit for a sub-burst offset is allocated in a sub-burst bitmap indicating sub-burst allocation when the data burst allocation information is determined to indicate the burst block for the MS;
checking the bit for the sub-burst offset of the MS when the bit for the sub-burst offset of the MS is determined to be present;
detecting that a sub-burst of the burst block for the MS is allocated when the bit for the sub-burst offset of the MS is set to 1 and checking a position of the sub-burst within the burst block; and
transmitting uplink data to the BS through the sub-burst of the burst block at a Modulation and Coding Scheme (MCS) level based on system setting.

47. The method of claim 46, wherein the data burst allocation information comprises a burst block allocation information element.

48. The method of claim 46, wherein the determining whether the data burst allocation information indicates the burst block for the MS comprises checking a burst block group identifier indicated by the data burst allocation information, and determining whether the burst block group identifier is equal to that allocated to the MS.

49. The method of claim 46, wherein the determining whether the bit for the sub-burst offset is allocated comprises retrieving the bit for the sub-burst offset of the MS from the sub-burst bitmap of a burst block allocation information element indicating sub-burst allocation within the burst block received from the BS.

50. The method of claim 46, wherein the checking the position of the sub-burst within the burst block comprises counting the number of bits set to 1 among bits mapped to sub-burst offsets of other MSs smaller than the sub-burst offset of the MS.

51. The method of claim 46, wherein the transmitting the uplink data to the BS comprises determining whether another burst block allocation information element is present within the uplink MAP message after transmitting the uplink data.

52. The method of claim 46, wherein the MS receives the uplink MAP message from the BS, and decodes a burst block allocation information element and an uplink MAP information element within the uplink MAP message.

53. A system for transmitting and receiving data in a communication system, the system comprising:
a Base Station (BS) for grouping Mobile stations (MSs) using a real-time service, into groups, allocating burst blocks to the groups, and allocating data bursts of burst blocks to the MS; and
an MS for determining whether its own uplink burst is allocated, and transmitting data to the BS through a sub-burst of a burst block allocated to a group to which the MS belongs.

54. The system of claim 53, wherein the BS groups MSs using an identical real-time service into one group.

55. The system of claim 53, wherein the BS broadcasts an uplink MAP message with Type/Length/Value (TLV) encoding comprising a burst block group IDentifier (ID) field for indicating an ID of a burst block allocated to a MS and a sub-burst offset field for identifying the mobile station in a burst block group.

56. The system of claim 55, wherein the BS broadcasts an uplink MAP message with the TLV encoding further comprising a sub-burst duration field for indicating a fixed size of data bursts in a connection between the BS and a MS, a repetition coding indication field for indicating a repetition of coding to be used and at least one of an Uplink Interval Usage Code (UIUC) field and a Modulation and Coding Scheme (MCS) level field for indicating a MCS level to be used when the MS transmits data in an allocated sub-burst.

57. The system of claim 56, wherein the BS transmits a value of the MCS level defined between the BS and the MS through the field of the TLV encoding.

58. The system of claim 56, wherein the BS transmits a UIUC value of an Uplink Channel Descriptor (UCD) message through the field of the TLV encoding.

59. The system of claim 56, wherein the MS detects a position of a data burst serving as an uplink resource allocated to itself using a combination of at least one of the TLV encoding fields.

60. The system of claim 53, wherein the BS uses a burst block allocation information element to periodically allocate fixed uplink resources to the MSs.

61. The system of claim 60, wherein the burst block allocation information element is comprised in an uplink MAP message.

62. The system of claim 60, wherein the burst block allocation information element comprises an extended-2 Uplink Interval Usage Code (UIUC) field for distinguishing extended information elements of an uplink MAP information element, a length field for indicating a message length of the burst block allocation information element, a burst block group IDentifier (ID) field for indicating a burst block group ID allocated to the MSs, a block duration field for indicating an end of the burst block, a length of sub-burst bitmap field for indicating a length of a sub-burst bitmap, and a sub-burst bitmap field for indicating which MS is assigned a sub-burst among MSs to which an identical block group ID is allocated.

63. The system of claim 53, wherein the BS allocates an N-th bit from a Most Significant Bit (MSB) of a sub-burst bitmap of a burst block allocation information element to a Mobile Station to which a sub-burst offset of N is allocated, the MS retrieving the N-th bit from the MSB of the sub-burst bitmap.

64. The system of claim 53, wherein the BS allocates sub-bursts to MSs using the sub-bursts of a burst block in a sequence of sub-burst offsets and sets a bit for each MS to which a sub-burst is allocated to 1.

65. The system of claim 53, wherein the MS determines that the BS has allocated a sub-burst of a burst block to a mobile station when an N-th bit of a sub-burst bitmap is set to 1, identifies the sub-burst of the burst block allocated to the MS from the sub-burst bitmap, counts the number of bits set to 1 before the bit allocated to the Mobile Station, and checks a sub-burst position of the MS using the counted number.

66. The system of claim 53, wherein MSs using a burst block allocated to an identical group among the burst blocks have the same data burst size as each other.

67. The system of claim 53, wherein MSs using a burst block allocated to an identical group among the burst blocks have the same Modulation and Coding Scheme (MCS) level as each other.
